(19) United States
(12) Patent Application Publication
(10) Pub. No.: US 2026/0088573 A1
(43) Pub. Date: Mar. 26, 2026

(54) CONNECTOR AND ASSEMBLY THEREOF WITH FOOLPROOF STRUCTURE

(71) Applicant: Luxshare Technologies International, Inc., MILPITAS, CA (US)

(72) Inventors: Rongzhe GUO, Dongguan City (CN); Hengshan CHENG, Dongguan City (CN); Hongji CHEN, Dongguan City (CN); Yunfeng HE, Dongguan City (CN)

(73) Assignee: Luxshare Technologies International, Inc., MILPITAS, CA (US)

(21) Appl. No.: 19/403,686

(22) Filed: Nov. 28, 2025

Related U.S. Application Data
(63) Continuation of application No. 17/839,873, filed on Jun. 14, 2022, now Pat. No. 12,512,626.

(30) Foreign Application Priority Data
Jun. 16, 2021 (CN) 202121340213.0

(51) Int. Cl. H01R 13/6581; H01R 12/72; H01R 12/75; H01R 13/648; H01R 13/658; H01R 13/6587; H01R 13/6596

(52) U.S. Cl. CPC H01R 13/6581; H01R 12/724; H01R 12/75; H01R 13/6587; H01R 13/648; H01R 13/658; H01R 13/6596

(57) ABSTRACT

A connector includes a metal shell and a terminal module coupled to the metal shell. The metal shell includes a main body, a shielding plate protruding from the main body, and a positioning plate further protruding from the shielding plate. The terminal module includes a first terminal module and a second terminal module disposed on opposite sides of the shielding plate, respectively. By providing the first terminal module and the second terminal module on the opposite sides of the shielding plate, the signal shielding of the first terminal module and the second terminal module can be improved. A connector assembly having the connector is also disclosed.

### CROSS-REFERENCE TO RELATED APPLICATIONS

This patent application is a continuation of U.S. patent application Ser. No. 17/839,873, filed on Jun. 14, 2022, which claims priority of a Chinese Patent Application No. 202121340213.0, filed on Jun. 16, 2021 and titled “CONNECTOR AND ASSEMBLY THEREOF”. The contents of the aforementioned applications are incorporated herein by reference in their entirety.

### TECHNICAL FIELD

The present disclosure relates to a connector and an assembly thereof, which belongs to a technical field of connectors.

### BACKGROUND

An existing connector assembly usually includes a connector and a mating connector. The connector includes an insulating housing, a terminal module secured to the insulating housing, a metal shell enclosing the insulating housing, and a cable electrically connected to the terminal module.

However, the connector in the relevant art has a large number of terminals and small intervals between the terminals, when transmitting high-speed signals, the transmission quality needs to be improved. In addition, the connector in the relevant art is often inserted at a wrong angle when the connector is mated with a mating connector, thereby damaging the terminals.

### SUMMARY

An embodiment of the present disclosure adopts the following technical solution: a connector including: a metal shell including a main body, a shielding plate protruding from the main body along a first direction, and a positioning plate further protruding from the shielding plate along the first direction; the shielding plate including a first surface and a second surface disposed opposite to the first surface; and at least one terminal module coupled to the metal shell, the at least one terminal module including a first terminal module at least partially disposed on the first surface, and a second terminal module at least partially disposed on the second surface; each of the first terminal module and the second terminal module including an insulating block and a plurality of terminal groups secured to the insulating block; each terminal group including a plurality of terminals; each terminal having a strip-shaped stiff contact portion exposed on the insulating block; the contact portions of the first terminal module being exposed to the shielding plate on one side, and the contact portions of the second terminal module being exposed to the shielding plate on another side.

Another embodiment of the present disclosure adopts the following technical solution: a connector assembly including: a connector, including: a metal shell including a main body, a shielding plate protruding from the main body along a first direction, and a positioning plate further protruding from the shielding plate along the first direction; the shielding plate including a first surface and a second surface disposed opposite to the first surface; and at least one terminal module coupled to the metal shell, the at least one terminal module including a first terminal module at least partially attached to the first surface, and a second terminal module at least partially attached to the second surface; each of the first terminal module and the second terminal module including an insulating block and a plurality of terminal groups secured to the insulating block; each terminal group including a plurality of terminals; each terminal having a strip-shaped stiff contact portion exposed on the insulating block; the contact portions of the first terminal module being exposed to the shielding plate on one side, and the contact portions of the second terminal module being exposed to the shielding plate on another side; and a mating connector, configured to mate with the connector, the mating connector including: a mating body, the mating body including a bottom wall, a first connecting wall connected to the bottom wall, a second connecting wall connected to the bottom wall, and a mating slot configured to receive the shielding plate; the first connecting wall and the second connecting wall being disposed on opposite sides of the mating slot; the bottom wall defining a positioning slot being in communication with the mating slot; and the positioning slot being configured to receive the positioning plate; a plurality of first mating terminals disposed in the first connecting wall, each first mating terminal including a first elastic mating arm extending into the mating slot and being configured to abut against a corresponding contact portion of the first terminal module; and a plurality of second mating terminals disposed in the second connecting wall, each second mating terminal including a second elastic mating arm extending into the mating slot and being configured to abut against a corresponding contact portion of the second terminal module.

### BRIEF DESCRIPTION OF DRAWINGS

FIG. 1 is a perspective schematic view of a connector assembly in accordance with an embodiment of the present disclosure, in which a connector is mated with a mating connector, and the mating connector is mounted on a circuit board;

FIG. 2 is a perspective schematic view of the connector assembly in accordance with the embodiment of the present disclosure, in which the connector is separated from the mating connector;

FIG. 3 is a partially exploded perspective view of the connector in accordance with the embodiment of the present disclosure;

FIG. 4 is a partially exploded perspective view of FIG. 3 from another angle;

FIG. 5 is a further perspective exploded view of FIG. 3;

FIG. 6 is a perspective view of a metal shell of the connector in accordance with the embodiment of the present disclosure;

FIG. 7 is a front view of the metal shell of the connector in accordance with the embodiment of the present disclosure;

FIG. 8 is a perspective exploded view of a terminal module of the connector in accordance with the embodiment of the present disclosure;

FIG. 9 is a further perspective exploded view of FIG. 8, in which a grounding piece is separated from an insulating block;

FIG. 10 is a perspective schematic view of FIG. 9 with the grounding piece and the insulating block removed;

FIG. 11 is a perspective exploded view of the mating connector in accordance with an embodiment of the present disclosure; and

FIG. 12 is a perspective view of a mating metal shell of the mating connector in accordance with the embodiment of the present disclosure.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

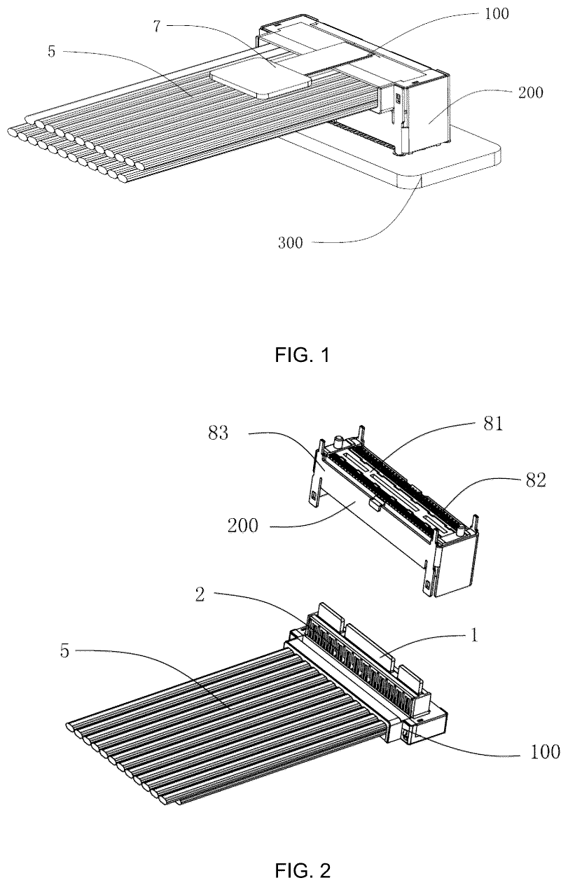

Referring to FIGS. 1 and 2, the present disclosure discloses a connector assembly including a connector 100 and a mating connector 200 which are adapted to mate with each other. In the illustrated embodiment of the present disclosure, the connector 100 is a cable connector, and the mating connector 200 is a board-end connector for being mounted on a circuit board 300. The connector 100 is adapted to mate with the mating connector 200 for data transmission.

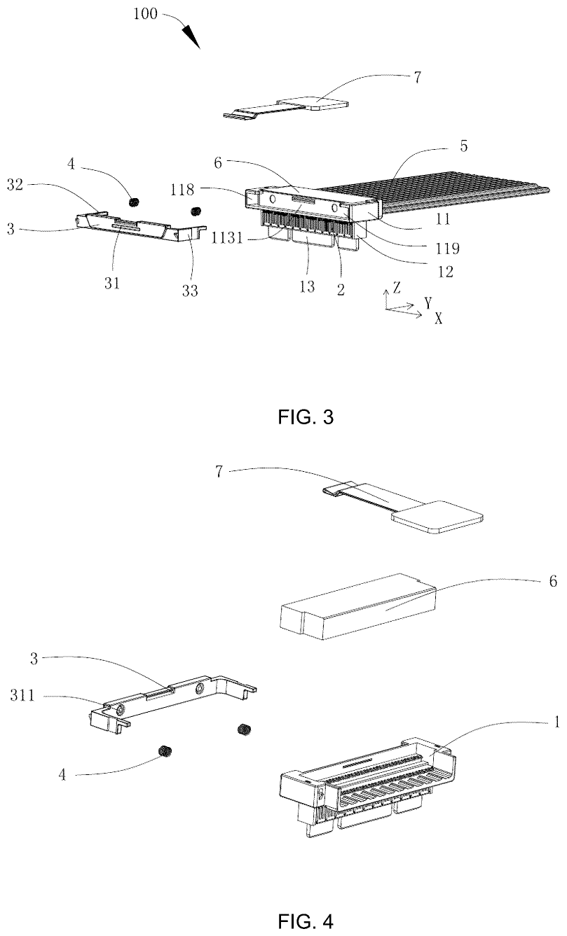

For the accuracy description of the present disclosure, all descriptions of directions of the connector assembly in the present disclosure refer to FIG. 3. An extension direction of an X axis is a left-right direction/a second direction, and it is defined that a positive direction of the X axis is a direction to the right. An extension direction of a Y-axis is a front-rear direction/a third direction, and it is defined that a positive direction of the Y-axis is a direction to the rear. An extension direction of a Z axis is a top-bottom direction/a first direction, and it is defined that a positive direction of the Z axis is a direction to the top. The connector and the mating connector are adapted to mate with each other in the top-bottom direction.

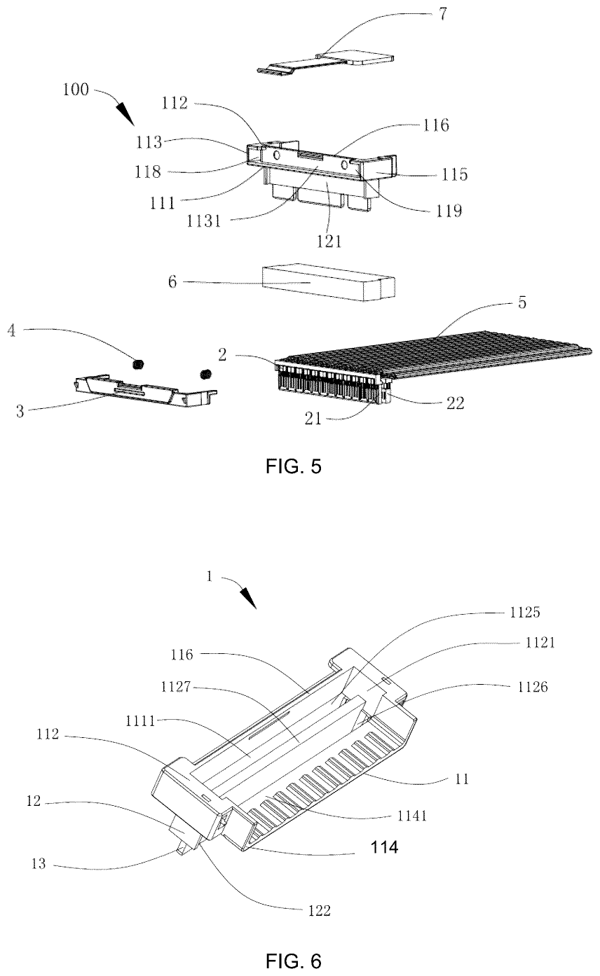

Referring to FIGS. 3 to 5, the connector 100 includes a metal shell 1, a terminal module 2 fixed to the metal shell 1, a movable member 3 assembled to the metal shell 1, an elastic member 4 used to abut against the movable member 3, a cable or cables 5 electrically connected to the terminal module 2, a cover plate 6 fastened to the metal shell 1 and at least partially abutting against the cables 5, and a pull strap 7 connected with the movable member 3. The pull strap 7 is capable of driving the movable member 3 to overcome the force of the elastic member 4 and to move in the front-rear direction.

The metal shell 1 includes a main body 11, a shielding plate 12 extending downwardly from the main body 11 and protruding beyond the main body 11, and a positioning plate 13 extending downwardly from the shielding plate 12 and protruding beyond the shielding plate 12. In the illustrated embodiment of the present disclosure, along the left-right direction and the front-rear direction, a size of the main body 11, a size of the shielding plate 12, and a size of the positioning plate 13 are sequentially reduced. Therefore, when viewed from a front-to-rear direction and a left-to-right direction, the metal shell 1 is substantially of a stepped configuration.

As shown in FIG. 6, the main body 11 includes a bottom wall 111, a top wall 112 opposite to the bottom wall 111, a front wall 113, a rear wall 114 opposite to the front wall 113, two side walls 115 connected between the top wall 112 and the bottom wall 111, a partition wall 116 connected between the two side walls 115, a receiving space 1131 located in front of the partition wall 116 and extending through the front wall 113, a first receiving slot 118 and a second receiving slot 119 located on left and right sides of the receiving space 1131, respectively, a connecting groove 1141 located behind the partition wall 116 and extending backwardly through the rear wall 114, a receiving space 1121 extending upwardly through the top wall 112, and a receiving groove 1111 extending downwardly through the bottom wall 111 from the connecting groove 1141.

The shielding plate 12 includes a first surface 121 and a second surface 122 which are opposite to each other.

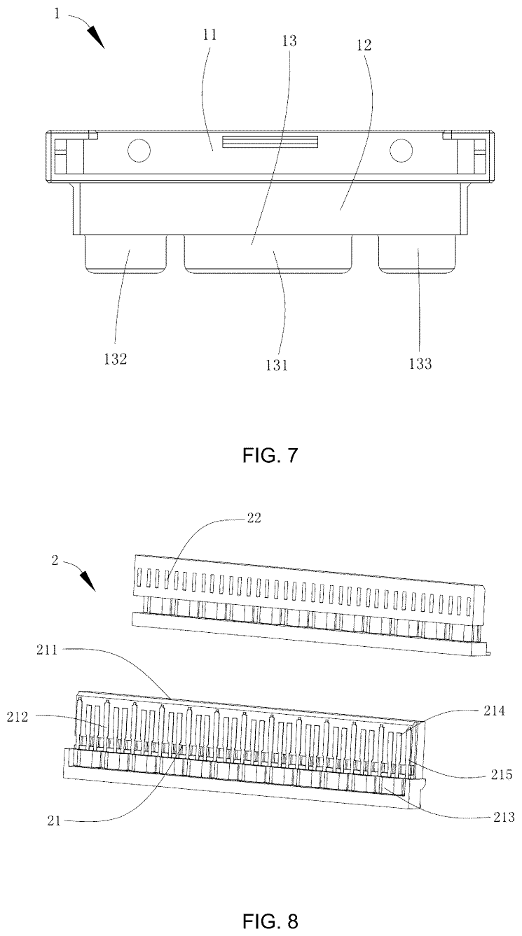

Referring to FIG. 7, in the illustrated embodiment of the present disclosure, the positioning plate 13 includes a first positioning piece 131 located in the middle, a second positioning piece 132 located on one side of the first positioning piece 131 and spaced apart from the first positioning piece 131, and a third positioning piece 133 located on the other side of the first positioning piece 131 and spaced apart from the first positioning piece 131. Preferably, in the left-right direction, a size of the first positioning piece 131 is larger than a size of the second positioning piece 132, and the size of the first positioning piece 131 is also larger than a size of the third positioning piece 133. In the illustrated embodiment of the present disclosure, the sizes of the first positioning piece 131, the second positioning piece 132, and the third positioning piece 133 are different, and a distance between the first positioning piece 131 and the second positioning piece 132 is different from a distance between the first positioning piece 131 and the third positioning piece 133. As a result, such features can play a foolproof effect, and can prevent the connector 100 from being mated with the mating connector 200 at a wrong angle.

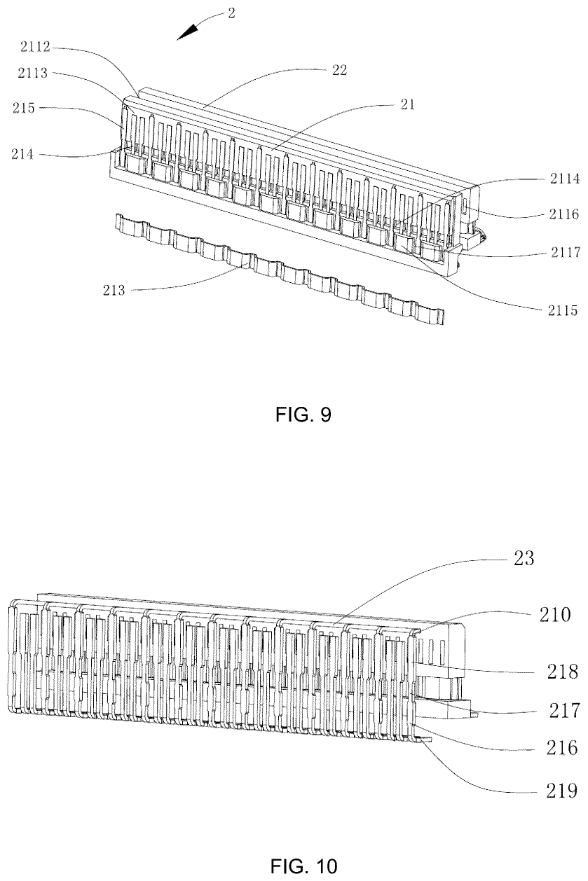

Referring to FIGS. 8 to 10, the terminal module 2 includes a first terminal module 21 and a second terminal module 22 disposed on opposite sides of the metal shell 1, respectively. Specifically, the first terminal module 21 is disposed on the first surface 121 of the shielding plate 12, and the second terminal module 22 is disposed on the second surface 122 of the shielding plate 12. Furthermore, the receiving groove 1111 includes a first receiving groove 1125 to accommodate the first terminal module 21, a second receiving groove 1126 to accommodate the second terminal module 22, and a partition 1127 disposed between the first receiving groove 1125 and the second receiving groove 1126. The second receiving groove 1126 is spaced apart from the first receiving groove 1125.

In an embodiment of the present disclosure, the first terminal module 21 and the second terminal module 22 have the same structure, so only the first terminal module 21 will be described in detail hereinafter.

The first terminal module 21 includes an insulating block 211, a plurality of terminal groups 212 fixed to the insulating block 211, and a grounding piece 213. Each terminal group 212 includes a plurality of differential signal terminal pairs 214 and a plurality of ground terminals 215 of which each is located between two adjacent differential signal terminal pairs 214. By providing the ground terminal 215 between two adjacent differential signal terminal pairs 214, the present disclosure can better improve the transmission quality.

Each of the differential signal terminal pairs 214 and the ground terminals 215 has a fixing portion 216 at least partially embedded in the insulating block 211, an extension portion 217 extending from one end of the fixing portion 216, a mating portion 218 extending from one end of the extension portion 217, and a connecting portion 219 extending from the other end of the fixing portion 216 and electrically connected to the cable 5. The fixing portion 216 of the ground terminal 215 is partially exposed to the insulating block 211. The ground terminal 215 also has a contact portion 210 which further extends from the mating portion 218 and is embedded in the insulating block 211. The contact portion 210 of each ground terminal 215 is connected in series by a connecting bridge 23, thereby further improving the signal transmission quality.

The insulating block 211 includes a first end surface 2112 opposite to the shielding plate 12, and a second end surface 2113 disposed opposite to the first end surface 2112. The mating portion 218 is exposed to the second end surface 2113. The insulating block 211 also includes a plurality of spacing grooves 2114, a plurality of protrusions 2115 and a plurality of connecting grooves 2116. The spacing grooves 2114 are recessed from the second end surface 2113 in a direction close to the first end surface 2112, and located between two adjacent extension portions 217. The protrusions 2115 protrude from the second end surface 2113 in a direction away from the first end surface 2112 and are located between the fixing portions 216 of two adjacent ground terminals 215. The connecting grooves 2116 are recessed from the first end surface 2112 toward a direction close to the second end surface 2113 and correspond to the position of each of the mating portions 218. Each of the mating portions 218 is at least partially exposed in a corresponding connecting groove 2116.

A groove 2117 is formed between each two adjacent protrusions 2115. The fixing portions 216 of the differential signal terminal pair 214 are embedded in the protrusion 2115. The fixing portion 216 of the ground terminal 215 is partially exposed in the groove 2117. A plurality of grooves 2117 form a wave-shaped mounting groove. A shape of the grounding piece 213 is of a long wave configuration. The grounding piece 213 is received in the mounting groove and covers the plurality of protrusions 2115 and the fixing portions 216 of the ground terminals 215 exposed in the grooves 2117, thereby enabling more stable signal transmission.

Referring to FIGS. 3 to 6, the movable member 3 is at least partially installed in the main body 11. Specifically, the movable member 3 includes a base 31 received in the receiving space 1131, a first push rod 32 extending from one side of the base 31 and received in the first receiving slot 118, and a second push rod 33 extending from the other side of the base 31 and received in the second receiving slot 119.

In the illustrated embodiment of the present disclosure, the elastic member 4 is a compression spring installed between the base 31 and the partition wall 116 of the main body 11. Preferably, two compression springs are provided and arranged side by side so as to improve the stability of the movable member 3 when moving. In addition, in order to better position the compression spring. The base 31 is also provided with at least one positioning post 311 at least partially inserted into the compression spring.

In the illustrated embodiment of the present disclosure, the cables 5 extend beyond the main body 11 in the front-rear direction and extend through the connecting grooves 1141 to be electrically connected to the terminal module 2.

The cover plate 6 is received and fixed in the receiving space 1121 of the main body 11. The pull strap 7 extends beyond the cover plate 6. In an embodiment of the present disclosure, the cover plate 6 presses against connection portions between the cables 5 and the terminal module 2 for protection.

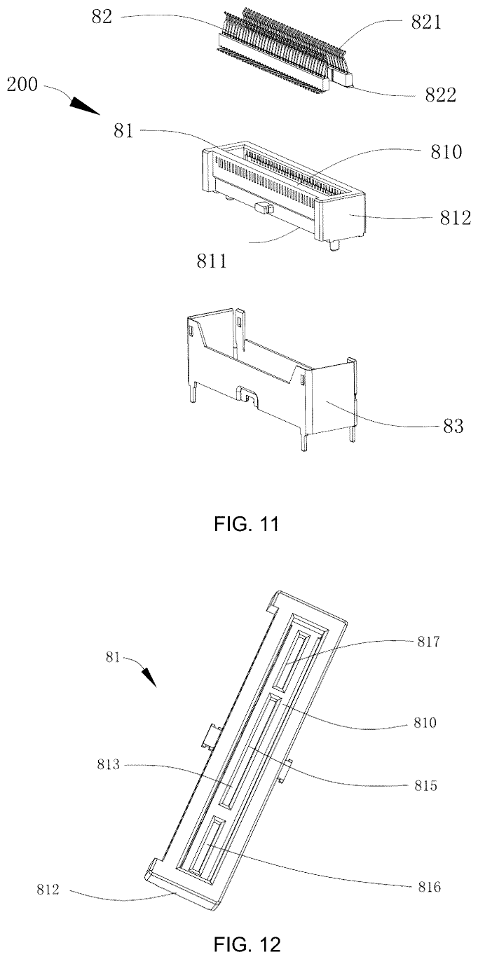

Referring to FIGS. 11 and 12, the mating connector 200 includes a mating metal shell 81, a plurality of mating terminals 82 fixed to the mating metal shell 81, and an outer metal shell 83 covering the mating metal shell 81.

The mating metal shell 81 includes a lower wall 811 and a plurality of connecting walls 812 perpendicular to the lower wall 811. The connecting walls 812 and the bottom wall 811 is enclosed to form a mating slot 810 for receiving the shielding plate 12. The lower wall 811 is provided with a plurality of positioning slots 813 for receiving the positioning plate 13. The positioning slots 813 are in communication with the mating slot 810. Specifically, the positioning slots 813 include a first positioning slot 815 to receive the first positioning piece 131, a second positioning slot 816 to receive the second positioning piece 132, and a third positioning slot 817 to receive the third positioning piece 133. In the illustrated embodiment of the present disclosure, the first positioning slot 815, the second positioning slot 816 and the third positioning slot 817 extend through the lower wall 811.

In the embodiment disclosed in the present disclosure, the positioning plate 13 of the connector 100 is provided with three positioning pieces 131, 132, 133. Correspondingly, the number of the positioning slots 813 of the mating connector 200 is also set to three. In other embodiments, the number of the positioning pieces 131, 132, 133 and the number of the positioning slots 813 may be adjusted according to actual needs. As long as there are at least two spaced positioning pieces with different sizes to mate with corresponding positioning slots, it can play a role in preventing foolishness.

The mating terminals 82 are arranged in two rows. Each mating terminal 82 includes an elastic mating arm 821 and a mounting tail 822 for being mounted to the circuit board 300. The elastic mating arms 821 extend into the mating slot 810 and are used to contact the mating portions 218.

When the connector 100 is inserted into the mating connector 200, the positioning plate 13 is correspondingly inserted into the positioning slot 813, the shielding plate 12 is inserted into the mating slot 810 correspondingly, and the mating portions 218 of the terminal module 2 are mated with the elastic mating arms 821 of the mating terminals 82. When the connector 100 needs to be pulled out, an external force is applied to pull the pull strap 7. The pull strap 7 generates a force component in the front-rear direction. The component force in this direction overcomes the force of the elastic member 4 and causes the movable member 3 to move in the front-rear direction, thereby pulling the connector 100 out of the mating connector 200.

The metal shell 1 of the connector 100 of the present disclosure is provided with the positioning plate 13 having a plurality of positioning pieces 131, 132, 133, and the sizes of the positioning pieces 131, 132, 133 are different. The mating metal shell 81 of the mating connector 200 is provided with the positioning slots 813 corresponding to the positioning plate 13. The positioning slots 813 include a plurality of positioning slots 815, 816, 817 corresponding to the positioning pieces 131, 132, 133. During the insertion process, these features can well prevent the connector 100 from being inserted into the mating connector 200 at a wrong angle.

The terminal module 2 of the connector 100 of the present disclosure includes the first terminal module 21 and the second terminal module 22 disposed on the opposite sides of the metal shell 1, respectively. The shielding plate 12 of the metal shell 1 is used to separate the first terminal module 21 and the second terminal module 22, which can reduce signal interference and improve transmission quality. Each of the ground terminals 215 is arranged between two adjacent pairs of the differential signal terminal pairs 214, which can better improve the transmission quality. The ground terminal 215 also has the contact portion 210 further extending from the mating portion 218 and embedded in the insulating block 211. The contact portions 210 are connected in series by the connecting bridge 23, thereby further improving the signal transmission quality. The insulating block 211 has a plurality of the spacing grooves 2114 located between two adjacent extension portions 217, a plurality of the protrusions 2115 located between the fixing portions 216 of two adjacent ground terminals 215, and a plurality of connecting grooves 2116 corresponding to the position of each of the mating portions 218. Each of the mating portions 218 is at least partially exposed in the connecting groove 2116. The groove 2117 is formed between two adjacent protrusions 2115. The fixing portions 216 of the differential signal terminal pair 214 are embedded in the protrusion 2115. The fixing portion 216 of the ground terminal 215 is partially exposed in the groove 2117. The grounding piece 213 covers the plurality of the protrusions 2115 and the plurality of the fixing portions 216 of the ground terminal 215 which are exposed in the grooves 2117, so that the signal can be transmitted more stably.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A connector, comprising:
a metal shell comprising a main body, a shielding plate protruding from the main body along a first direction, and a positioning plate further protruding from the shielding plate along the first direction; the shielding plate comprising a first surface and a second surface disposed opposite to the first surface; and
at least one terminal module coupled to the metal shell, the at least one terminal module comprising a first terminal module at least partially disposed on the first surface, and a second terminal module at least partially disposed on the second surface; each of the first terminal module and the second terminal module comprising an insulating block and a plurality of terminal groups secured to the insulating block; each terminal group comprising a plurality of terminals; each terminal having a strip-shaped stiff contact portion exposed on the insulating block; the contact portions of the first terminal module being exposed to the shielding plate on one side, and the contact portions of the second terminal module being exposed to the shielding plate on another side.

2. The connector according to claim 1, wherein the main body, the shielding plate and the positioning plate are of a stepped configuration with a size of the main body along a second direction, a size of the shielding plate along the second direction, and a size of the positioning plate being reduced in sequence along the second direction;
wherein the contact portions of the first terminal module are exposed to the shielding plate on the one side along a third direction, and the contact portions of the second terminal module are exposed to the shielding plate on the another side along the third direction; and
wherein each two of the first direction, the second direction and the third direction are perpendicular to each other.

3. The connector according to claim 2, wherein the positioning plate comprises at least two positioning pieces arranged at intervals and with different sizes along the second direction.

4. The connector according to claim 3, wherein the positioning plate comprises a first positioning piece, a second positioning piece and a third positioning piece; and wherein the second positioning piece and the third positioning piece are spaced apart from the first positioning piece, and are located on opposite sides of the first positioning piece, respectively.

5. The connector according to claim 4, wherein a size of the first positioning piece is larger than a size of the second positioning piece along the second direction, and the size of the first positioning piece is larger than a size of the third positioning piece along the second direction.

6. The connector according to claim 5, wherein a distance between the first positioning piece and the second positioning piece along the second direction is different from a distance between the first positioning piece and the third positioning piece along the second direction.

7. The connector according to claim 2, wherein the terminals of each terminal group comprise a plurality of differential signal terminal pairs and a plurality of ground terminals; and two ground terminals are disposed on two sides of each differential signal terminal pair, respectively, along the second direction.

8. The connector according to claim 7, wherein each of the first terminal module and the second terminal module comprises a grounding piece in contact with the ground terminals thereof.

9. The connector according to claim 2, wherein the main body comprises a first receiving groove, a second receiving groove, and a partition disposed between the first receiving groove and the second receiving groove; the first receiving groove is configured for the first terminal module to be inserted and pass therethrough; and the second receiving groove is configured for the second terminal module to be inserted and pass therethrough.

10. The connector according to claim 1, further comprising a plurality of cables electrically connected to the terminals of the first terminal module and the terminals of the second terminal module.

11. The connector according to claim 1, further comprising a movable member assembled to the metal shell, an elastic member abutting against the movable member, and a pull strap connected with the movable member; wherein the movable member comprises a base, a first push rod extending from one side of the base, and a second push rod extending from another side of the base; and wherein the pull strap is configured to drive the movable member to overcome a force of the elastic member and to move.

12. A connector assembly, comprising:
a connector, comprising:
a metal shell comprising a main body, a shielding plate protruding from the main body along a first direction, and a positioning plate further protruding from the shielding plate along the first direction; the shielding plate comprising a first surface and a second surface disposed opposite to the first surface; and
at least one terminal module coupled to the metal shell, the at least one terminal module comprising a first terminal module at least partially attached to the first surface, and a second terminal module at least partially attached to the second surface; each of the first terminal module and the second terminal module comprising an insulating block and a plurality of terminal groups secured to the insulating block; each terminal group comprising a plurality of terminals; each terminal having a strip-shaped stiff contact portion exposed on the insulating block; the contact portions of the first terminal module being exposed to the shielding plate on one side, and the contact portions of the second terminal module being exposed to the shielding plate on another side; and
a mating connector, configured to mate with the connector, the mating connector comprising:
a mating body, the mating body comprising a bottom wall, a first connecting wall connected to the bottom wall, a second connecting wall connected to the bottom wall, and a mating slot configured to receive the shielding plate; the first connecting wall and the second connecting wall being disposed on opposite sides of the mating slot; the bottom wall defining a positioning slot being in communication with the mating slot; and the positioning slot being configured to receive the positioning plate;
a plurality of first mating terminals disposed in the first connecting wall, each first mating terminal comprising a first elastic mating arm extending into the mating slot and being configured to abut against a corresponding contact portion of the first terminal module; and
a plurality of second mating terminals disposed in the second connecting wall, each second mating terminal comprising a second elastic mating arm extending into the mating slot and being configured to abut against a corresponding contact portion of the second terminal module.

13. The connector assembly according to claim 12, wherein the main body, the shielding plate and the positioning plate are of a stepped configuration with a size of the main body along a second direction, a size of the shielding plate along the second direction, and a size of the positioning plate being reduced in sequence along the second direction;
wherein the contact portions of the first terminal module are exposed to the shielding plate on the one side along a third direction, and the contact portions of the second terminal module are exposed to the shielding plate on the another side along the third direction; and
wherein each two of the first direction, the second direction and the third direction are perpendicular to each other.

14. The connector assembly according to claim 13, wherein the positioning plate comprises at least two positioning pieces arranged at intervals and with different sizes along the second direction.

15. The connector assembly according to claim 14, wherein the positioning plate comprises a first positioning piece, a second positioning piece and a third positioning piece;
and wherein the second positioning piece and the third positioning piece are spaced apart from the first positioning piece, and are located on opposite sides of the first positioning piece, respectively.

16. The connector assembly according to claim 15, wherein a size of the first positioning piece is larger than a size of the second positioning piece along the second direction, and the size of the first positioning piece is larger than a size of the third positioning piece along the second direction.

17. The connector assembly according to claim 16, wherein a distance between the first positioning piece and the second positioning piece along the second direction is different from a distance between the first positioning piece and the third positioning piece along the second direction.

18. The connector assembly according to claim 13, wherein the terminals of each terminal group comprise a plurality of differential signal terminal pairs and a plurality of ground terminals; and two ground terminals are disposed on two sides of each differential signal terminal pair, respectively, along the second direction; and
wherein each of the first terminal module and the second terminal module comprises a grounding piece in contact with the ground terminals thereof.

19. The connector assembly according to claim 13, wherein the main body comprises a first receiving groove, a second receiving groove, and a partition disposed between the first receiving groove and the second receiving groove; the first receiving groove is configured for the first terminal module to be inserted and pass therethrough; and the second receiving groove is configured for the second terminal module to be inserted and pass therethrough.

20. The connector assembly according to claim 13, wherein the connector further comprises a movable member assembled to the metal shell, an elastic member abutting against the movable member, and a pull strap connected with the movable member; wherein the movable member comprises a base, a first push rod extending from one side of the base, and a second push rod extending from another side of the base; and wherein the pull strap is configured to drive the movable member to overcome a force of the elastic member and to move.
